(19) United States
(12) Patent Application Publication
(10) Pub. No.: US 2025/0388126 A1
(43) Pub. Date: Dec. 25, 2025

(54) Method for electrically connecting a set of battery packs in parallel, an electronic control unit, a computer program, a computer readable storage medium, a battery system and a vehicle

(71) Applicant: Webasto SE, Stockdorf (DE)

(72) Inventors: Alberto Lucas Mariscal, Stockdorf (DE); Yashwanth Dasappagari, Stockdorf (DE); Alaba Akinwande, Stockdorf (DE)

(21) Appl. No.: 18/877,843

(22) PCT Filed: Jun. 29, 2023
(86) PCT No.: PCT/EP2023/067813

§ 371 Date: Dec. 20, 2024

(30) Foreign Application Priority Data
Jun. 29, 2022 (DE) 10 2022 116 264.8

(51) Int. Cl. B60L 58/22; B60L 58/21; H01M 10/48; H01M 50/512; H01M 50/514

(52) U.S. Cl. CPC B60L 58/22; B60L 58/21; H01M 10/486; H01M 50/512; H01M 50/514; B60L 2240/545; B60L 2240/547

(57) ABSTRACT

A method for electrically connecting a set of battery packs in parallel to reduce balancing currents due to inhomogeneous battery packs, where to keep balancing currents minimal, a first battery pack with a highest or with a lowest measured voltage value is selected and connected to an output of the battery system.

### CROSS-REFERENCE TO RELATED APPLICATIONS

This application is a 35 U.S.C. § 371 National Stage Entry of International Application No. PCT/EP2023/067813 filed Jun. 29, 2023, which claims the priority benefit of German Patent Application Serial Number DE 10 2022 116 264.8 filed Jun. 29, 2022, all of which are incorporated herein by reference in their entirety for all purposes.

### TECHNICAL FIELD

The invention relates to a method for electrically connecting a set of battery packs in parallel, an electronic control unit, a computer program, a computer readable storage medium, a battery system and a vehicle.

### BACKGROUND

It is known to provide a high-voltage battery system for an electric vehicle which comprises at least two battery packs which each may comprise one or a group of battery modules, wherein each battery module comprises a group of battery cells. The battery packs together form the battery system and provide the electrical energy for electric drives or other auxiliary components of the vehicle. The battery packs are usually placed in different locations of the vehicle.

To electrically connect several battery packs together safely e.g. at startup, the battery packs should have the same operation parameters such as voltage, temperature and state of charge (SOC). Otherwise, imbalances pertaining to one parameter can lead to large balancing currents between the connected battery packs which would lead to a reduction of lifetime or even a damage of the contactors and battery cells in the battery packs.

Particularly, connecting several battery packs will lead to high balancing current flows. This may result in a fast capacity fade of the battery cells, particularly of lithium-ion battery cells, due to temperature, state of charge and voltage differences between the respective battery packs. This overall leads to a lower energy throughput of the battery system as energy capacities in each battery pack remain unused when inhomogeneous battery packs are connected. In extreme cases, large current imbalances could lead to a destruction of high-voltage components in the battery system such as contactors or a pre-charge resistor.

EP 3 078 073 B1 describes a method for balancing a battery consisting of a plurality of battery cells wherein a first group of battery cells which are charged to a full state of charge (SOC) and a second group of battery cells which are charged partly to a preferred state of charge lower than the full state of charge are singled out from a group of randomly selected battery cells which are to be balanced.

To provide balancing, the battery cells in the first group are bypassed to charge the battery cells of the second group until the battery cells of both groups reach the preferred state of charge. The selection of battery cells within the battery can be permutated for an equal distribution of the state of charge over all battery cells of the battery. As only single battery cells are balanced, the problem of balancing currents which are high enough to cause damage to contactors of the battery system does not arise.

DE 10 2009 000 055 A1 shows a battery consisting of a plurality of battery cells wherein the battery cells are balanced by means of an energy conversion circuit. A first group of battery cells with a higher state of charge above an average threshold state of charge is selected which are to transfer their excess electrical energy via the energy conversion circuit to a second group of battery cells whose state of charge is below the average threshold state of charge until the battery cells of the first group and the second group reach the average threshold state of charge.

DE 10 2018 000 581 A1 describes a method for balancing a battery consisting of a plurality of battery cells wherein each battery cell is tuned by an electronic control unit to a state of charge which is within a range of an average state of charge of all battery cells by means of individual charging or discharging of the respective battery cell by the electronic control unit. Furthermore, a diagnostic information about the state of health of the respective battery cell is considered wherein defective battery cells are discharged entirely.

### SUMMARY

It is an object of the present invention to provide a method for keeping balancing currents low in a battery system comprising a set of battery packs which are electrically connected in parallel.

The invention relates to a method for electrically connecting a set of battery packs to an output by means of a switching arrangement to form a battery system, preferably for a vehicle, wherein each of the respective battery packs comprises a number of battery cells, wherein a voltage value for each battery pack is measured by means of a sensor arrangement. The method comprises the steps of:
selecting a first battery pack from the set of battery packs, the first battery pack having the highest measured voltage value or the lowest measured voltage value;
connecting the first battery pack to the output;
setting a maximum allowable deviation threshold value for connecting a second battery pack from the set of battery packs;
selecting a second battery pack from the set of battery packs such that the difference between the measured voltage value of the second battery pack and the measured voltage value of the first battery pack is below or equal the deviation threshold value; and
connecting the second battery pack to the output.

In other words, the battery system may comprise a set of battery packs which are connected by means of the switching arrangement to the output of the battery system to provide electrical energy to a high-voltage component of the vehicle or to receive electrical energy from a charging device, such as an on-board charger of the vehicle, via the output. Receiving electrical energy via the output may be a charging operation of the battery system while transferring electrical energy to the high-voltage component via the output may be a discharging operation of the battery system.

The battery packs may be arranged in different locations in a vehicle.

The battery cells in the battery packs may be organized in battery modules within the battery pack. The battery modules may comprise a plurality of battery cells which are connected in series or in parallel in the battery module to provide the desired voltage and/or capacity.

The battery modules in the battery packs may be connected in series or in parallel or in a combination thereof in order to provide the desired voltage and/or capacity of the battery pack, e.g. a 400V or 800V arrangement.

A battery pack may comprise a housing which receives the battery cells and/or the battery modules. The housing preferably provides a sealed enclosure such that the battery pack can be arranged in the vehicle in a safe manner.

The battery packs of the vehicle can preferably be connected in parallel in order to achieve the desired overall capacity of the battery-system but could also be connected in series if a desired output voltage of the battery system is to be achieved by the combination.

It is known to provide a high-voltage battery system for an electric vehicle which comprises at least two battery packs which each may comprise one or a group of battery modules, wherein each battery module comprises a group of battery cells. The battery packs together form the battery system and provide the electrical energy for electric drives or other auxiliary components of the vehicle. The battery packs are usually placed in different locations of the vehicle.

The battery packs or battery modules may comprise lithium-ion or lithium-polymer battery cells for instance. The battery packs may also comprise at least one battery module wherein each battery module comprises a group of battery cells.

The battery packs may be connected in parallel via the switching arrangement to the output wherein each battery pack may comprise a group of serially and/or parallel connected battery modules and/or battery cells.

The battery system may furthermore comprise a sensor arrangement, particularly a measurement probe which is connected to an electronic control unit and is adapted to measure a voltage value of each battery pack and/or of each battery module and/or of each battery cell in the respective battery pack. The electronic control unit may measure the voltage value of each battery pack and/or of each battery module and/or of each battery cell in the respective battery pack by means of the sensor arrangement. For instance, the electronic control unit may calculate the voltage value of the respective battery pack by summing up the measurement voltage values of each battery cell or each battery module in said battery pack. The voltage value for each battery pack and/or for each battery module and/or each battery cell may preferably be measured in each cycle, particularly before the first battery pack is selected.

Supplementary, the electronic control unit may measure the voltage of each battery pack before selecting the first battery pack if the number of battery packs which already are connected to the output is zero. If the number of battery packs which already are connected to the output is greater than zero, the electronic control unit may skip the step of connecting the first battery pack to the output in each connection cycle.

If the number of battery packs which are already connected to the output is zero, the first battery pack may be selected from the set of all battery packs of the battery system with the highest or lowest measured voltage value and be connected to the output. The maximum allowable deviation threshold value is to limit a balancing current between the battery packs which already are connected to the output and which comprise the first battery pack and the recently connected second battery pack. The deviation threshold value may be a fixed voltage value, such as a voltage value lower or equal than 10 V for instance.

To limit the balancing current, the second battery pack or group of second battery packs may be selected such that the amount of deviation between the measured voltage value of the second battery pack and the measured voltage value of the first battery pack is below or equal the deviation threshold value. This may be expressed by the equation below for the case of selecting the first battery pack with the highest measured voltage value

$$0 \leq \vert ( {U}_{grp , m ax} - {U}_{k} ) \vert \leq Δ {U}_{li m} \qquad ( 1 )$$

whereas the case of selecting the first battery pack with the lowest measured voltage value may be expressed by the equation

$$0 \leq \vert ( {U}_{grp , m i n} - {U}_{k} ) \vert \leq Δ {U}_{li m} \qquad ( 2 )$$

wherein U_{grp,max} denotes the highest voltage and U_{grp,min} the lowest voltage of the first battery pack comprising a group of serially and/or parallel connected battery cells. The battery system may comprise k battery packs in total wherein a voltage value Uₖ of the battery pack k may be measured for each battery pack of the battery system by the electronic control unit by means of the sensor arrangement. This may be expressed by the relation U_{grp,max}∈Uₖ and U_{grp,min}∈Uₖ. The highest or lowest measured voltage value may be therefore:

$${U}_{grp , m ax} = max ( {U}_{1} , {U}_{2} , … , {U}_{k} ) \qquad ( 3 )$$

$${U}_{grp , m i n} = min ( {U}_{1} , {U}_{2} , … , {U}_{k} ) \qquad ( 4 )$$

For instance, the battery system may comprise 10 different battery packs which are not yet connected to the output, hence k∈{0, 1, 2, 3, 4, 5, 6, 7, 8, 9, 10}. The respective battery pack k may comprise n battery cells, which may be connected in series wherein the voltage of each battery cell n in the battery pack k may be denoted by U_{k,n}. The measured voltage value of the respective battery pack Uₖ may therefore be calculated by the electronic control unit as:

$${U}_{k} = {U}_{k , 1} + ⋯ + {U}_{k , n} \qquad ( 5 )$$

The cycle may terminate if the number of battery packs k which are not yet connected to the output is zero or if the number of battery packs which are connected to the output is equal to k. Said method minimizes a balancing current flow while multiple battery packs of different voltage and/or temperature and/or state of charge levels are connected to the output of the battery system.

The battery system may be a 400 V or a 800 V battery system which may be adapted for use in a vehicle.

This has the advantage that equalization currents in battery systems comprising a set of several battery packs, particularly of battery packs connected in parallel, are reduced compared to an approach in which all battery packs are connected at the same time. This prevents the destruction of high-voltage components such as contactors due to high balancing currents which can occur after the connection of the battery packs. This also prevents a fast capacity fade of the battery system, particularly an aging process of a battery cell due to high balancing currents after connecting inhomogeneous battery packs. Furthermore, an energy throughput in connected battery packs of a battery system may be increased. Said battery system also has the advantage that it can be used for a charging or discharging operation even if not all battery packs have exactly the same state of charge or a voltage. Furthermore, disconnected battery packs of the battery system in a vehicle can be connected to the output of the battery system during driving or charging of a vehicle when the allowed level for connection is reached.

Typically, battery packs which are already connected to the output share the same voltage value. This shared voltage can be used as the reference for a highest U_{grp,max} or a lowest U_{grp,min} voltage value.

In one specific embodiment, the first battery pack is selected from the set of battery packs which are connected to the output if at least one battery pack from the set of battery packs is already connected to the output. In other words, a charging or discharging operation performed on the battery packs which already are connected to the output may vary the voltage value of said battery packs. Particularly, the voltage value of each of said battery packs connected to the output may vary at different speeds. Thus, the first battery pack having the highest or lowest measured voltage value may be selected among the battery packs which already are connected to the output from scratch if the number of battery packs already connected to the output is greater than zero and/or if a charging or discharging operation is detected. If the number of battery packs which already are connected to the output is greater than zero and/or if a charging or discharging operation is detected, the electronic control unit may measure the voltage value of each battery pack which already is connected to the output and/or skip the step of connecting the first battery pack to the output in each cycle. This is advantageous as the voltage value of the battery packs which already are connected to the output may vary, particularly at different speeds, due to a charging or discharging operation of the battery system, whereas the voltage value of the battery packs which are disconnected from the output may essentially remain constant before a specific time period has elapsed.

This has the advantage that changes of an energy level of the battery packs which are connected to the output due to a charging or discharging operation may be taken into account. A charging operation of the battery pack may be providing electrical energy to a high-voltage component of the vehicle, for example an electric motor. A charging operation may be receiving electrical energy from an on-board charger of the vehicle via the output. Furthermore, this has the advantage that disconnected battery packs of the battery system in a vehicle can be connected to the output of the battery system during driving or charging of a vehicle when the allowed level for connection is reached.

In one embodiment, the second battery pack is selected such that the difference between the measured voltage value of the second battery pack and the measured voltage value of the first battery pack is the smallest of all pairs of first and second battery packs. In other words, one second battery pack with the least difference between the measured voltage value Uₖ and the measured voltage value of the first battery pack U_{grp,max} or U_{grp,min} may be selected from a group of second battery packs whose amount of difference between the respective measured voltage value Uₖ and the measured voltage value U_{grp,max} or U_{grp,min} of the first battery pack is below or equal the deviation threshold value. This condition may be expressed by: min(|U_{grp,max}−Uₖ|≤ΔUₗᵢₘ) or min(|U_{grp,min}−Uₖ≤ΔUₗᵢₘ) for all k. This has the advantage that in each cycle, the one second battery pack with the least voltage deviation from the highest or lowest measured voltage value of the first battery pack is selected. This has the advantage that equalization currents appearing after connecting the second battery pack in parallel to the first battery pack are minimized.

In one embodiment, the deviation threshold value is determined by means of a decision matrix which registers the respective deviation threshold value based on a number and/or a voltage of the battery packs which are already connected to the output and/or an average state of charge and/or an average temperature of the battery system and/or an amount of a current which flows in or out of the battery system. In other words, the decision matrix may be a look-up table or a database comprising a list of deviation threshold values ΔUₗᵢₘ which are calculated by means of a simulation or by means of measurement statistics of balancing currents of the battery system using a selection of at least one of the parameters: the number N of battery packs which are connected to the output, the average state of charge SOC_{avg}, the average temperature T_{avg}, an amount of current |I| flowing in or out of the battery system and additionally a voltage U_{N} of the battery packs which are connected to the output. The respective deviation threshold value ΔUₗᵢₘ may be accessed in the decision matrix, particularly the database, by means of a respective value of the respective parameter based on a sensor reading of the sensor arrangement. Preferably, sensor readings of the parameters number N of battery packs, the average state of charge SOC_{avg}, the average temperature T_{avg} and the amount of current |I| are used for the decision matrix.

For instance, the deviation threshold value ΔUₗᵢₘ may be calculated by a function based on four parameters, such as:

$$Δ {U}_{li m} = f ( {SOC}_{avg} , {T}_{avg} , \vert I \vert , N ) \qquad ( 6 )$$

A first boundary condition for the differential voltage may be

$$Δ {U}_{li m} \leq 10 V ∀ N = \{ 1 , 2 , 3 , 4 , 5 , 6 , 7 , 8 , 9 \} \qquad ( 7 )$$

wherein N denotes the number of battery packs for the decision matrix which are connected to the output.

A second boundary condition for the differential voltage ΔUₗᵢₘ may be:

$$Δ {U}_{l im} = 0 ∀ N = 0 \qquad ( 8 )$$

If the number of battery packs which are connected to the output is zero, hence N=0, the differential voltage may be set to zero.

One parameter for the function of equation (6) may be the average state of charge SOC_{avg} of the battery system comprising N battery packs, which already are connected to the battery system. Said parameter may be calculated by:

$${SOC}_{a v g} = \frac{{SOC}_{avg , grp 1} + {SOC}_{avg , grp 2} + ⋯ + {SOC}_{avg , grpN}}{N} \qquad ( 9 )$$

wherein SOC_{avg,grpN} denotes the average state of charge of a group of battery cells in the respective battery pack N which already is connected to the output. For example, each battery pack comprises a group of n battery cells which may be connected in series. Therefore, the state of charge of the respective battery pack may correspond to the lowest state of charge of the battery cell in the respective battery pack. This may be expressed by the equation:

$${SOC}_{avg , grpN} = min ( {SOC}_{N , 1} , {SOC}_{N , 2} , … , {SOC}_{N , n} ) \qquad ( 10 )$$

wherein SOC_{N,n} denotes the state of charge of respective battery cell n in the battery pack N.

One parameter for the function of equation (6) may be the average temperature T_{avg} of the battery packs which are connected to the output. The average temperature may be determined by the equation

$${T}_{avg} = \frac{{T}_{avg , grp 1} + {T}_{avg , grp 2} + ⋯ + {T}_{avg , grpN}}{N} \qquad ( 11 )$$

wherein T_{avg,grpN} denotes the average temperature of a group of battery cells in the respective battery pack which already is connected to the output. Hence, the average temperature T_{avg,grpN} of the respective battery pack N may be an average value between a first battery cell with a highest temperature T_{max(N,1)} and a second battery cell with a lowest temperature T_{min(N,2)} in the respective battery pack N:

$${T}_{avg , grpN} = \frac{{T}_{ma x , ( N , 1 )} + {T}_{m i n , ( N , 2 )}}{2} \qquad ( 12 )$$

wherein T_{N,n} depicts the temperature in respective battery n cell in battery pack N.

One parameter for the function of equation (6) may be the amount of current |I| flowing in our or out of the battery system via the output. For instance, the current may flow out of the battery system via the output during a discharging operation and the current may flow into the battery system via the output during a charging operation. A direction of the current I may be considered for the selection of the first battery pack to be connected to the output. For instance, in case of a charging operation the first battery pack may be the battery pack with the lowest U_{grp,min} measured voltage value and in case of a discharging operation the first battery pack may be the battery pack with the highest U_{grp,max} measured voltage value.

One parameter for the function of equation (6) may be the number N of battery packs which are connected to the output of the battery system. For instance, the battery system may comprise k battery packs, wherein each battery pack may comprise n battery cells. For instance, the battery pack may comprise a number of battery cells from 1 to 10, hence n∈{1, 2, 3, 4, 5, 6, 7, 8, 9, 10}.

If the total number of battery packs in the battery system is k, the maximum value for N denoting the number of battery packs already connected to the output for the decision matrix which comprises the values for connecting one further battery pack to the output may be 0 to N=k−1, hence N∈{0, 1, 2, 3, 4, 5, 6, 7, 8, 9} if k=10. Whereas, if the number of battery packs already connected to the output is k, hence N=k, the cycle may terminate as all battery packs already are connected.

Additionally, the voltage U_{N} of the battery packs which already are connected to the output may be considered as a parameter for the deviation threshold value ΔUₗᵢₘ. This may be advantageous for a dynamic case wherein a voltage value of the respective battery pack which is connected to the output may change due to a charging or discharging operation. For instance, the voltage U_{N} may be a highest or a lowest or an average voltage of the battery packs which are connected to the output. The respective battery packs connected to the output may charge or discharge at different speeds due to a charging or discharging operation that is conducted on the battery system. This may be due to different life cycles or aging of the battery cells in the respective battery packs. Hence, the highest U_{grp,max} or lowest U_{grp,min} measured voltage value of the battery packs, preferably of the battery packs already connected to the output, may be measured anew in each cycle if a charging or discharging operation is detected by the electronic control unit.

This provides the technical effect that the maximum allowable deviation threshold value is adapted to the respective operation mode of the battery system to keep balancing currents low in each operation mode based on a selection of the respective operational parameter of the battery system. The use of a decision matrix, particularly as a database for accessing the respective deviation threshold value based on a selection of said parameters, may furthermore reduce a processing time period of an electronic control unit in case a limited number of input parameters is used for determining the deviation threshold value. For instance, in case a selection of three of said parameters is used to determine the deviation threshold value such as the number of battery packs connected to the output and the average state of charge and the average temperature, the time required to retrieve said deviation threshold value from the database may require less time than running a simulation by the electronic control unit.

In one embodiment, the deviation threshold value is calculated by means of a simulation of the battery system, particularly of a simulation of balancing currents in the battery system, based on the number and/or a voltage of the battery packs which are already connected to the output and/or the average state of charge and/or the average temperature of the battery system and/or the amount of a current which flows in or out of the battery system. In other words, the simulation may calculate a maximum allowable voltage difference between the second battery pack to be connected to the output and the highest or lowest measured voltage value of the first battery pack based on an amount of an allowable balancing current. The allowable balancing current may be simulated based on sensor readings of the sensor arrangement based on at least one of the parameters: the number N of battery packs which are connected to the output, the average state of charge SOC_{avg}, the average temperature T_{avg}, an amount of current |I| flowing in or out of the battery system and additionally a voltage U_{N} of the battery packs which are connected to the output. Preferably, sensor readings of the parameters number N of battery packs, the average state of charge SOC_{avg}, the average temperature T_{avg} and the amount of current |I| are used for the simulation.

The use of a simulation in each cycle for connecting the second battery pack to the output also provides the technical effect that the maximum allowable deviation threshold value is adapted to the respective operation mode of the battery system to keep balancing currents low in each operation mode. The use of a simulation may be advantageous, in case a several input parameters for determining the deviation threshold value are used, for instance more than three parameters. In this case, the processing time of the simulation may be shorter than the time required to retrieve the respective deviation threshold value from the database.

In one embodiment, the first battery pack with the highest measured voltage value is selected to be connected to the output by means of the switching arrangement in case of a discharging operation of the battery system and/or that the first battery pack with the lowest measured voltage value is selected to be connected to the output by means of the switching arrangement in case of a charging operation of the battery system. In other words, the electronic control unit may detect the charging or discharging operation based on a sensor reading of the current flow I by means of the sensor arrangement and/or whether electrical energy may be required or requested from a vehicle interface to the output of the battery system. In case of a discharging operation, for example providing electrical energy to an electric motor of the vehicle, the first battery pack with the highest measured voltage value and/or the highest state of charge may be connected first to the output of the battery system for discharging. The discharging may furthermore reduce the voltage of the first battery pack such that the difference between the measured voltage value Uₖ of the second battery pack and the measured voltage value of the first battery pack may be further reduced after a specified period of time for an initial discharging of the first battery pack has elapsed.

Supplementary or alternatively, in case of a charging operation, for example receiving electrical energy from an on-board charger of a vehicle, the first battery pack with the lowest measured voltage value and/or the lowest state of charge may be connected first to the output of the battery system for charging. The charging may furthermore increase the voltage of the first battery pack such that the difference between the measured voltage value of the second battery pack and the measured voltage value of the first battery pack may be further reduced after a specified period of time for an initial charging of the first battery pack has elapsed.

Supplementary, if the number of second battery packs whose amount of difference between the measured voltage value of said second battery pack and the measured voltage value of the first battery pack is below or equal the deviation threshold value is zero, the electronic control unit may charge or discharge the battery packs which are connected to the output, particularly the first battery pack, for the specified period of time before resuming selecting the second battery pack from the remaining disconnected battery packs.

This has the advantage that an imbalance between the first and second battery pack can be reduced further by decreasing the difference between the measured voltage value of the second battery pack and the measured voltage value of the first battery pack before connecting the second battery pack.

The invention also relates to an electronic control unit for a battery system, preferably a battery management system, comprising means adapted to execute the steps of said method. In other words, the electronic control unit may comprise or be adapted to be connected to a sensor arrangement for measuring at least one parameter of: the number N of battery packs which are connected to the output, the average state of charge SOC_{avg}, the average temperature T_{avg}, a current I flowing in or out of the battery system and additionally a voltage Uₖ of the battery packs, particularly a voltage of the battery modules and/or of the battery cells in the respective battery pack. The electronic control unit may furthermore comprise a communication interface for sending a connection or disconnection command to the switching arrangement, for instance a command for opening or closing the respective switches which connect or disconnect the respective battery pack from the switching arrangement. The electronic control unit may comprise at least one processor and a computer readable storage medium, wherein the computer readable storage medium comprises instructions which, when executed by the at least one processor, cause the electronic control unit to execute said method on the battery packs of a battery system. For this, the electronic control unit may be a battery management system of a battery, preferably for a vehicle. The at least one processor may be a microprocessor and/or a microcontroller and/or a FPGA (Field Programmable Gate Array and/or a DSP (Digital Signal Processor).

The invention also relates to a computer program comprising instructions to cause the electronic control unit to execute the steps of the method. In other words, the computer program may be installed on a computer readable storage medium in an electronic control unit of a battery, preferably of a battery management system.

The invention also relates to a computer readable storage medium having stored thereon said computer program. In other words, the computer readable storage medium may be a punched card, a (floppy) disk storage medium, a hard disk, a CD, a DVD, an USB (Universal Serial Bus) storage device, a RAM (Random Access Memory), a ROM (Read Only Memory) and/or an EPROM (Erasable Programmable Read Only Memory). Preferably, the computer readable storage medium may be a RAM or a ROM, wherein particularly a flash memory is used. The computer readable storage medium may also be a data communication network which allows downloading a program code, such as the Internet for example, or further systems. The electronic control unit, preferably the battery management system, comprises said computer readable storage medium. The computer program may preferably be an embedded systems application which preferably may be implemented in C programming language.

The invention also relates to a battery system, preferably for a vehicle, comprising said electronic control unit, preferably said battery management system. The battery system may represent a battery for a vehicle, such as lithium-ion or a lithium-polymer battery for instance.

The battery system may comprise a sensor arrangement for measuring at least one parameter of: the number N of battery packs which are connected to the output, the average state of charge SOC_{avg}, the average temperature T_{avg}, a current I flowing in or out of the battery system and additionally a voltage Uₖ of the battery packs, particularly a voltage of the battery cells in the respective battery pack.

The battery system may furthermore comprise a communication line for sending a connection or disconnection command to the switching arrangement, for instance a command line for opening or closing the respective switches which connect or disconnect the respective battery pack from the switching arrangement. Furthermore, the battery system may be adapted to be controlled by said electronic control unit and/or said computer program being executed by at least one processor of the electronic control unit such that a charging or discharging operation of the battery system may be detected by the electronic control unit and the method for connecting or disconnecting a battery pack from the output be executed by the electronic control unit. This has the advantage that a constant operating voltage level can be provided by the battery system and that balancing the battery system does not interfere with the current operation mode of the battery system.

The invention furthermore relates to a vehicle comprising said battery system and/or said electronic control unit.

The vehicle may comprise high-voltage components which are adapted to receive or transfer electrical energy to the battery system via a vehicle interface and the output of the battery system. For this, the vehicle may comprise an interface to be connected to the output of the battery system. For instance, the high-voltage components may be an electric motor or an on-board charger. The vehicle may be designed as a motor vehicle, in particular as a passenger car or truck, or as a passenger bus or motorcycle, wherein the electric vehicle is particularly designed as an electric or a hybrid vehicle.

### DESCRIPTION OF THE FIGURES

In the following, the present disclosure will be explained in more detail with reference to the accompanying Figures, showing:

FIG. 1 is a schematic view of a battery system comprising a set of battery packs which is connected via an interface to high-voltage components of a vehicle;

FIG. 2 is a schematic view of a command loop for an electronic control unit of the battery system for connecting a battery pack to an output of the battery system; and

FIG. 3 is a schematic flow chart of the method for connecting a battery pack to the output of the battery system.

### DETAILED DESCRIPTION OF THE FIGURES

The embodiment explained below is a preferred embodiment of the invention. In the embodiment, the described components of the embodiment each represent individual features of the invention to be considered independently of one another, which also further form the invention independently of one another in each case and are thus also to be regarded as a component of the invention individually or in a combination other than that shown. In the Figures, like elements are denoted by identical reference numerals and repeated description thereof may be omitted in order to avoid redundancies.

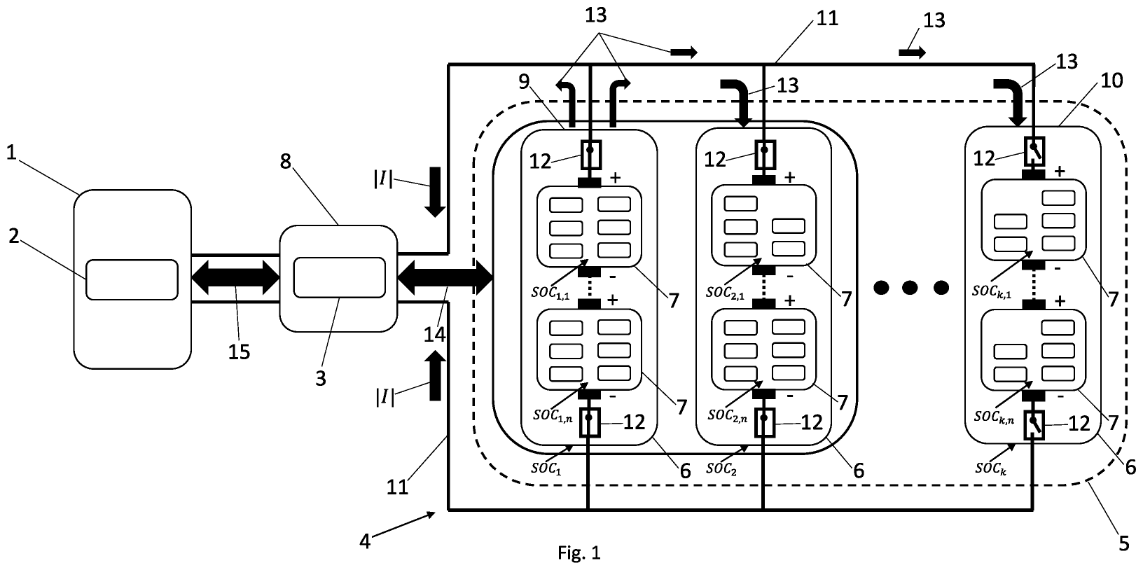

FIG. 1 shows a schematic view of a battery system 4 which is adapted to deliver electrical energy 15 to a high-voltage component 2 of a vehicle 1 or to receive electrical energy 15 from a high-voltage component 2 of the vehicle 15 via an output 8 of the battery system 4 and a corresponding vehicle interface 2 of the vehicle 1. The high-voltage component 2 may for example be an on-board charger or an electric engine.

For instance, in an electric vehicle 1 with a high-voltage battery system 4, several battery packs 6 are integrated in the battery system 4 which together provide the electrical energy 15 for a high-voltage component 2 of the vehicle 1 such as electric drives or auxiliary components. Each of the battery packs 6 has its own high-voltage contactors and can thus be connected and disconnected separately from the switching arrangement 11 by means of the switches 12 to provide the required electrical energy 15 to or receive the electrical energy 15 from the vehicle 1 via the output 8.

The battery system 4 comprises a set of k battery packs 6 with a respective state of charge SOCₖ which are adapted to be electrically connected via the switching arrangement 11, wherein a closing or opening of the switch 12 may connect or disconnect the respective battery pack 6 from the switching arrangement 11. For example, the switching arrangement 11 may be adapted to electrically connect the battery packs 6 in parallel. Particularly, the switching arrangement 11 may be adapted to connect the battery packs 6 first to form a series strings and then to connect the series strings in parallel depending on a required high voltage architecture. An electronic control unit 3, for example a battery management system, may be adapted to control and/or to measure by means of a sensor arrangement the amount of electric current |I| which flows in or out of the battery system 4, particularly the respective battery packs 6 which are connected to the output 8, by means of a connection command loop 14.

The electronic control unit 3 may be adapted to connect or disconnect the battery packs 6 of the battery system 4 via the switching arrangement 11, that is by means of closing or opening the respective switch 12, to adapt the battery system 4 to an amount of electrical energy 15 to be transmitted in a current operation mode of the battery system 4 such as a charging or a discharging mode to a high-voltage component 2 of the vehicle 1. The respective battery pack 6 comprises a group of n battery cells 7 which are connected in parallel (or in series in an alternative embodiment), wherein the respective battery cell n in the battery pack k may have an individual state of charge SOC_{k,n}.

This may lead to that the battery packs 6 may respectively have a different state of charge SOCₖ, wherein imbalance currents 13 between the respective battery packs 6 occur. When connecting the battery packs 6 in parallel by means of the switching arrangement 11 to the output 8, this can lead to a balancing current flow 13 which may be high enough to cause damage to the battery system 4 such as contactors or a pre-charge resistor or an electrical fuse. The balancing current 13 may flow from the first battery pack 9 which is connected to the output 8 with the highest state of charge SOC₁ and/or the highest voltage U_{grp,max} respectively to the battery packs 6 which are connected to the output 8 with a lower state of charge, such as the module 6 with the respective state of charge SOC₂. Otherwise, the balancing current 13 may flow from the battery packs 6 with a higher state of charge which are connected to the output 8 to the first battery pack 9 with the lowest state of charge SOC₁ and/or the lowest voltage U_{grp,min} which is connected to the output 8.

To connect serval battery packs 6 in parallel safely, the battery packs 6 should have the same voltage, temperature and a state of charge. Otherwise, imbalances may lead to a balancing current 13 which flows between the battery packs 6 which are electrically connected by means of the switching arrangement 11. If the voltage and state of charge of the connected battery packs 6 and 9 are different above a threshold value, particularly a voltage threshold value ΔUₗᵢₘ, balancing currents 13 large enough to cause damage to the switches 12 and to the battery packs 6 may occur. The amount of balancing current 13 may depend on the parameters of a number N of battery packs 6 which are connected in parallel by means of the switching arrangement 11 and/or an average state of charge SOC_{avg} and/or an average temperature T_{avg} of said N connected battery packs 6 and 9 and/or an amount of current flow |I| in or out of the battery system 4. In the example of FIG. 1, the two battery packs 6 and 9 are connected in parallel by means of the switching arrangement 11, wherein the respective switches 12 are closed, hence N=2 in the example of FIG. 1.

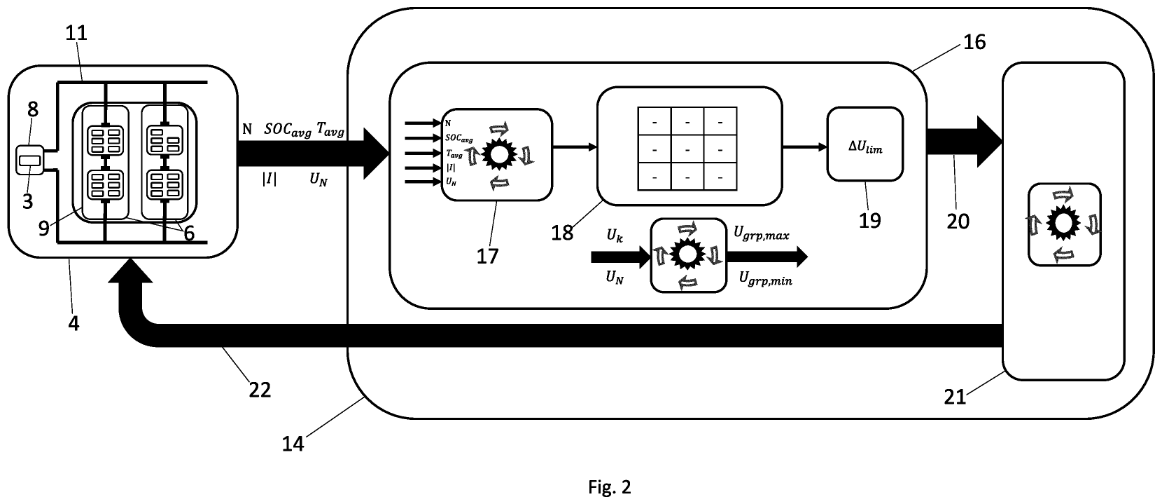

The amount of balancing current 13 is reduced by means of the connection command loop 14 which may be executed by the electronic control unit 3 which may translate said parameters for the amount of balancing current 13 to a voltage threshold value ΔUₗᵢₘ for deciding on connecting a second battery pack 10 to the switching arrangement 11 or not by means of a decision matrix 18 and/or a simulation. This is shown in further detail in FIG. 2.

FIG. 2 schematically depicts the command loop 14 for the electronic control unit 3 of the battery system 4 for deciding on whether to connect a second battery pack 10 to the output 8 of the battery system 4 by means of the electronic control unit 3 wherein the electronic control unit 3 may be adapted to execute said connection command loop 14. For this, the electronic control unit 3 may be adapted to measure the number N of battery packs 6 which are already connected to the output 8 and/or an average state of charge SOC_{avg} and/or an average temperature T_{avg} and/or a current I flowing in or out of the battery system 4 via the output 8 and/or a current voltage value U_{N} of the battery packs 6 which are already connected to the output 8 by means of a sensor arrangement. The sensor arrangement may be a measurement probe for instance. Preferably, the number N of battery packs 6 which are already connected to the output 8 and the average state of charge SOC_{avg} and the average temperature T_{avg} may be used as input parameters 17. The input parameters 17 are thereby based on sensor readings of the sensor arrangement which are transmitted to the electronic control unit 3.

Based on the input parameters 17, a deviation threshold value ΔUₗᵢₘ is determined by means of a decision matrix 18 and/or a simulation as an output value 19 which denotes a maximum allowable voltage difference ΔUₗᵢₘ between a measured voltage value of a first battery pack 9 which is already connected to the output 8 and the voltage value of the second battery pack 10 which is to be connected to the output. The decision matrix 18 may therefore serve as a database for retrieving the current deviation threshold value ΔUₗᵢₘ based on current sensor readings of the input parameters 17. The decision matrix 18 and/or may translate the sensor readings of a combination of said input parameters 17, preferably the number N of battery packs 6 which are already connected to the output 8 and the average state of charge SOC_{avg} and the average temperature T_{avg}, into a voltage value ΔUₗᵢₘ as a maximum allowable amount of deviation 20.

The connection decision state machine 21 is adapted to decide whether to connect the respective second battery pack 10 from the remaining battery packs 6 in the battery system 4 to the output 8. For this, the connection decision state machine 21 is adapted to decide on connecting the respective second battery pack 10 to the output 8 if the amount of difference between the measured voltage value Uₖ of the second battery pack 10 and the measured voltage value U_{grp,max} or U_{grp,min} of the first battery pack 9 is below or equal the deviation threshold value ΔUₗᵢₘ, hence |U_{grp,max}−Uₖ|≤ΔUₗᵢₘ or |U_{grp,min}−Uₖ|≤ΔUₗᵢₘ.

Preferably, the connection decision state machine 21 may select the second battery pack 10 with the minimum difference value, such that the difference between the measured voltage value Uₖ of the second battery pack 10 and the measured voltage value U_{grp,max} or U_{grp,min} of the first battery pack 9 is the smallest of all pairs of first and second battery packs, hence min(|U_{grp,max}−Uₖ|≤ΔUₗᵢₘ) or min(|U_{grp,min}−Uₖ|≤ΔUₗᵢₘ) for all k.

The decision state machine 21 may be adapted to output a connection command 22 to connect the second battery pack 10 to the output 8 by means of the respective switches 12 of the switching arrangement 11. The electronic control unit 3 may comprise the decision state machine 21 and the connection algorithm 16. Furthermore, the electronic control unit 3 may comprise or have access to a database that forms the decision matrix 18.

Supplementary or alternatively, the electronic control unit 3 may be adapted to execute said simulation which outputs the deviation threshold value ΔUₗᵢₘ based on a combination of the input parameters 17.

If the number N of battery packs 6 which already are connected to the output 8 is zero, a voltage value Uₖ of all battery packs 6, particularly of the first battery pack 9 and the second battery pack 10, is measured. The first battery pack 9 with the highest measured voltage value U_{grp,max} IS selected by the electronic control unit 3 if the current flows out of the battery system 4 whereas the first battery pack 9 with the lowest voltage value U_{grp,max} is selected by the electronic control unit 3 if the current flows into the battery system 4. The first battery pack 9 is connected to the output 8 by means of sending a connection command 22 for closing or opening to the respective switches 12 of the switching arrangement 11 from the electronic control unit 3. The electronic control unit 3 may be adapted to send the connection command 22 to open or close the respective switches 12 of the switching arrangement 11 to connect or disconnect the respective battery pack 6. If the number N of battery packs 6 which already are connected to the output 8 is larger than zero, the electronic control unit 3 may measure the voltage value U_{N} of these battery packs 6 and determine the first battery pack 6 with the highest U_{grp,max} or lowest U_{grp,min} voltage value.

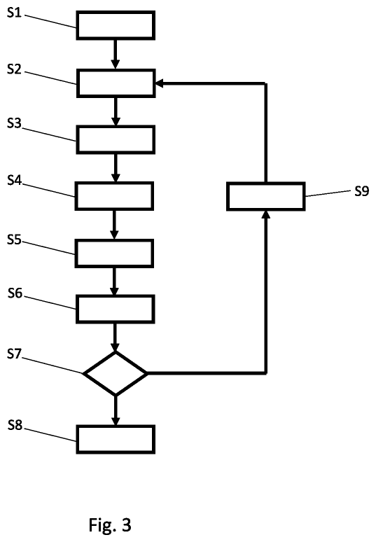

FIG. 3 depicts a flow chart of the method to connect a set of battery packs 6 of a battery system 4 in parallel.

In a first step S1, a voltage value Uₖ is measured for each battery pack 6 of the battery system 4.

The electronic control unit 3 may be adapted to measure said voltage value for each battery pack 6 by means of a sensor arrangement 11 such as a measurement probe for each battery pack 6 or supplementary for each battery cell 7 in the respective battery pack 6.

In a second step S2, a first battery pack 9 with a highest U_{grp,max} or a lowest U_{grp,min} voltage value is selected from the battery packs 6 of the battery system 4. If a discharging operation of the battery system 4 is detected by the electronic control unit 3, hence current flows out of the battery system 4 via the output 8, the first battery pack 9 with the highest voltage value U_{grp,max} is selected and if a charging operation is detected by the electronic control unit 3, hence current flows into the battery system 4 via the output 8, the first battery pack 9 with the lowest voltage value U_{grp,min} is selected. For this, the electronic control unit 3 may be adapted to measure a direction of the current flow I via the output and determine the discharging or charging operation and/or to receive a request or offer of electrical energy 15 from the vehicle interface 2.

Typically, the battery packs 6 which are already connected to the output share the same voltage value. This shared voltage can be used as the reference for the a highest U_{grp,max} or a lowest U_{grp,min} voltage value.

In case said battery packs 6 discharge or charge at different speeds, due to aging effects for instance, an additional step may be added to step S2. If the number N of battery packs 6 already connected to the output 8 is different than zero, the first battery pack 9 may be selected among the battery packs 6 which are already connected to the output 8. For this, the electronic control unit 3 may be adapted to measure the voltage value U_{N} for each battery pack 6 already connected to the output 8 and select the battery pack 6 as first battery pack 9 with the highest U_{grp,max} or the lowest U_{grp,min} voltage value.

In a third step S3, the first battery pack 9 is connected to the output 8 by means of the switching arrangement 11. For this, the electronic control unit 3 may be adapted to send a connection command 22 to close the respective switches 12 for connecting the first battery pack 9 to the switching arrangement 11 and hence to the output 8. If the number N of battery packs 6 already connected to the output 8 is different than zero, the step S3 is skipped.

In a fourth step S4, a maximum allowable deviation threshold value ΔUₗᵢₘ for connecting a second battery pack 10 from the remaining battery packs 6 of the battery system 4 is set, wherein the deviation threshold value ΔUₗᵢₘ may be determined by means of a decision matrix 18 based on a selection of the input parameters 17, preferably the number N of battery packs 6 which are already connected to the output 8 and the average state of charge SOC_{avg} and the average temperature T_{avg}.

Supplementary or alternatively, deviation threshold value ΔUₗᵢₘ may be calculated by a simulation of the battery system, preferably a simulation of balancing currents 13 in the battery system depending on the input parameters 17, preferably the number N of battery packs 6 which are already connected to the output 8 and the average state of charge SOC_{avg} and the average temperature T_{avg}.

In a fifth step S5, a second battery pack 10 from the remaining battery packs 6 in the battery system 4 is selected if the amount of deviation between the voltage value Uₖ of the second battery pack 10 and the measured voltage value U_{grp,max} or U_{grp,min} of the first battery pack 9 is below or equal the deviation threshold value ΔUₗᵢₘ. Hence, the condition for selecting the second battery pack 10 may be |U_{grp,max}−Uₖ|≤ΔUₗᵢₘ Or |U_{grp,min}−Uₖ|≤ΔUₗᵢₘ.

Preferably the second battery pack 10 whose amount of deviation between the voltage value Uₖ and the highest U_{grp,max} or lowest U_{grp,min} voltage value is a minimum value is selected, hence the condition may preferably be min(|U_{grp,max}−Uₖ|≤ΔUₗᵢₘ) or min(|U_{grp,min}−Uₖ|≤ΔUₗᵢₘ) for all battery packs k which are not yet connected to the output 8.

In a sixth step S6, the selected second battery pack 10 is connected to the output 8 and hence in parallel to the battery packs 6 which already are connected to the output 8. The emerging balancing currents 13 after connection are thus limited such that no damage to the battery packs 6 and particularly to a contactor may be caused.

In a seventh step S7, the electronic control unit 3 may check whether at least one battery pack 6 of the battery system 4 remains disconnected from the output 8. If the number of disconnected battery packs 6 is zero, the method may terminate in step S8. In case at least one battery pack 6 remains disconnected, the voltage value Uₖ of each battery pack k in the battery system 4, preferably of the battery packs 6 which already are connected to the output 8 is measured by the electronic control unit 3 by means of the sensor arrangement 11 as to in case of a charging or discharging operation, the voltage of the battery packs 6 which are already connected to the output 8 may change. The method is repeated starting from step S2, wherein step S3 is skipped, until the condition for terminating of step S7 is fulfilled.

It will be obvious for a person skilled in the art that these embodiments and items only depict examples of a plurality of possibilities. Hence, the embodiments shown here should not be understood to form a limitation of these features and configurations. Any possible combination and configuration of the described features can be chosen according to the scope of the invention.

### LIST OF REFERENCE NUMERALS

Vehicle 1
Vehicle interface to high-voltage components 2
Electronic control unit for the battery system 3
Battery system 4
Set of battery packs 5
Battery pack 6
Battery cell 7
Output of the battery system 8
First battery pack 9
Second battery pack 10
Switching arrangement 11
Switch 12
Balancing current flow 13
Connection command loop 14
Electrical energy 15
Connection algorithm 16
Input parameter 17
Decision matrix 18
Output value 19
Amount of deviation 20
Connection decision state machine 21
Connection command 22
State of charge of battery pack n SOCₙ
Deviation threshold value ΔUₗᵢₘ
Maximum voltage value U_{grp,max}
Minimum voltage value U_{grp,min}
Voltage of the battery pack k Uₖ
Number of battery packs connected to the output N
Voltage of a battery pack connected to the output U_{N}
Average state of charge of the battery system SOC_{avg}
Average temperature of the battery system T_{avg}
Current flow in or out of the battery system |I|
First step S1
Second step S2
Third step S3
Fourth step S4
Fifth step S5
Sixth step S6
Seventh step S7
Eighth step S8
Ninth step S9

1: A method for electrically connecting a set of battery packs in parallel to an output by means of a switching arrangement to form a battery system, wherein each of the respective battery packs comprises a number of battery cells, wherein a voltage value for each battery pack is measured by means of a sensor arrangement, the method comprising the steps of:
selecting a first battery pack from the set of battery packs, the first battery pack having the highest measured voltage value or the lowest measured voltage value;
connecting the first battery pack to the output;
setting a maximum allowable deviation threshold value for connecting a second battery pack from the set of battery packs;
selecting a second battery pack from the set of battery packs such that the difference between the measured voltage value of the second battery pack and the measured voltage value of the first battery pack is below or equal the deviation threshold value; and
connecting the second battery pack to the output.

2: The method according to claim 1, wherein the second battery pack is selected such that the difference between the measured voltage value of the second battery pack and the measured voltage value of the first battery pack is the smallest of all pairs of first and second battery packs.

3: The method according to claim 2, wherein the deviation threshold value is determined by means of a decision matrix which registers the respective deviation threshold value based on at least one of: a number of the battery packs and/or a voltage of the battery packs which are already connected to the output, an average state of charge, an average temperature of the battery system, and an amount of a current which flows in or out of the battery system.

4: The method according to claim 3, wherein the deviation threshold value is calculated by means of a simulation of the battery system, based on at least one of: the number of the battery packs, a voltage of the battery packs which are already connected to the output, the average state of charge, the average temperature of the battery system, and the amount of a current which flows in or out of the battery system.

5: The method according to claim 4, wherein at least one of: the first battery pack with the highest measured voltage value is selected to be connected to the output by means of the switching arrangement in case of a discharging operation of the battery system and the first battery pack with the lowest measured voltage value is selected to be connected to the output by means of the switching arrangement in case of a charging operation of the battery system.

6: An electronic control unit for a battery system, wherein the electronic control unit comprises means configured to:
select a first battery pack from the set of battery packs, the first battery pack having the highest measured voltage value or the lowest measured voltage value;
connect the first battery pack to the output;
set a maximum allowable deviation threshold value for connecting a second battery pack from the set of battery packs;
select a second battery pack from the set of battery packs such that the difference between the measured voltage value of the second battery pack and the measured voltage value of the first battery pack is below or equal the deviation threshold value; and
connect the second battery pack to the output.

7-8. (canceled)

9: A battery system for a vehicle (1), comprising an electronic control unit configured to:
select a first battery pack from the set of battery packs, the first battery pack having the highest measured voltage value or the lowest measured voltage value;
connect the first battery pack to the output;
set a maximum allowable deviation threshold value for connecting a second battery pack from the set of battery packs;
select a second battery pack from the set of battery packs such that the difference between the measured voltage value of the second battery pack and the measured voltage value of the first battery pack is below or equal the deviation threshold value; and
connect the second battery pack to the output.

10. (canceled)

11: The method according to claim 4, wherein the simulation of the battery system is a simulation of balancing currents in the battery system.
